(19) United States
(12) Patent Application Publication
(10) Pub. No.: US 2014/0281604 A1
(43) Pub. Date: Sep. 18, 2014

(54) Autonomous Power Sparing Storage

(71) Applicant: Charles Robert Martin, Superior, CO (US)

(72) Inventor: Charles Robert Martin, Superior, CO (US)

(21) Appl. No.: 13/831,683

(22) Filed: Mar. 15, 2013

(51) Int. Cl. G06F 1/32; G06F 1/26

(52) U.S. Cl. CPC G06F 1/3268; G06F 1/26
USPC 713/320; 713/300

(57) ABSTRACT

Power saving logic in a data storage system with multiple data storage devices is distributed from a central controller to each individual device. Power saving logic, including algorithms used to conserve power when the data storage device is not needed, are stored and executed on each individual data storage device. Hence, rather than implementing a power saving algorithm from a single central sever, each and every data storage system may carry out power saving techniques individually. This reduces the load on the central server and utilizes processing power available on data storage devices such as a disk drive.

### BACKGROUND OF THE INVENTION

1. Field of the Invention

The present invention generally relates to controlling the power consumption of an intelligent data storage device. More specifically, the present invention relates to a plurality of data storage devices that contain power saving logic.

2. Description of the Related Art

The modern data center contains a plurality of rotating media data storage devices and solid-state data storage devices. The most common form of rotating media today is disk drives. Disk drives store data on magnetically coated disks. Data on these disks may be read, written, or overwritten sequentially or randomly.

Data on the disk drive's disk is read or written using a “head”. These disk drive heads detect magnetic fields when reading data, and generate magnetic fields when writing data. To accomplish the reading and writing of data, the disk drive heads are moved across the disk and positioned accurately with an actuator.

Typically, the disks in a disk drive spin continuously and an actuator maintains position of the heads over the disk. Keeping these disks spinning and keeping the actuator positioned expends power. When the disk drive is active yet not servicing data requests, the spinning disks and actuator waste power. When a system with a hundred or more disk drives is wasting power, the costs increase to the data storage owner. There is a need for an improved power saving method for data storage systems.

### SUMMARY OF THE CLAIMED INVENTION

The invention distributes power saving logic in a data storage system with multiple data storage devices, replacing logic contained in a central controller with logic stored in each individual device. Power saving logic, including algorithms used to conserve power when the data storage device is not needed, are stored and executed on each individual data storage device. Hence, rather than implementing a power saving algorithm from a single central sever, each and every data storage system may carry out power saving techniques individually. This reduces the load on a central server and utilizes processing power available on data storage devices such as a disk drive.

A data storage device may include non-volatile solid state memory, a rotating medium, and a processor. The rotating medium may be configured to store non-volatile data. The processor may execute a module stored on the data storage device to control the power state of the rotating medium based at least in part on queued requests to read or write to the rotating medium.

### BRIEF DESCRIPTION OF THE DRAWINGS

FIG. 1 illustrates a distributed data storage system.

FIG. 2 illustrates a shelf within a distributed data storage system.

FIG. 3 illustrates a data storage device.

FIG. 4 illustrates a power saving algorithm performed by a data storage device.

### DETAILED DESCRIPTION

The invention distributes power saving logic in a data storage system with multiple data storage devices from a central controller to each individual device. Power saving logic, including algorithms used to conserve power when the data storage device is not needed, are stored and executed on each individual data storage device. Hence, rather than implementing a power saving algorithm from a single central sever, each and every data storage system may carry out power saving techniques individually. This reduces the load on the central server and utilizes processing power available on data storage devices such as a disk drive.

Various power saving modes are available for disk drives, such as an idle mode and sleep mode. Typically, the idle mode turns off an actuator, and sleep turns off an actuator and the disks. When the disk drives are operating in a power saving mode and they receive a data access command, additional time is required for the disk drive to service that command as the disk drive must power up to service the command. This reduces the overall performance of the computer system since a disk drive may take seconds to power up from sleep.

In previous systems, systems of multiple disk drives are configured to accept power saving commands from a system controller or host computer to help conserve power. FIG. 1 illustrates a distributed data storage system typical of previous systems. In the system of FIG. 1, data storage units 115, 120 and 125 may each include multiple disk drives. Each data storage unit 115-125 may receive power saving commands from system controller 110. Hence, the power saving processing and decisions for each and every drive within data storage units 115-125 occurs at system controller 110.

The present invention may include logic in the form of software that manages power consumption at the data storage device level rather than a system or unit controller level. FIG. 2 illustrates a shelf within a distributed data storage system. The data storage unit (shelf) of FIG. 2 includes a unit controller 210, server motherboard 215, a plurality of disk drives 220, and a JBOD (“just a bunch of drives”) 225. The unit controller 210 may communicate with each disk drive 220 and JBOD 225 to control access, read, and write functions, and other functions to the data storage devices. Server motherboard 215 may include logic and perform processing for data storage unit 200, and communicate with external devices such as system controller 110 in FIG. 1.

Each of the plurality of disk drives may include power saving software module 222. The power saving software may be stored in memory of each disk drive and executed by a processor to perform power saving techniques for that particular disk drive. The power saving techniques may include one or more algorithms for reducing power used by a rotating disk of the particular disk drive. The algorithm may provide or not provide power based on one of several conditions, including the number of requests in a write queue and/or read queue, history of use for the rotating disk, the queue length, and other conditions.

FIG. 3 illustrates a simplified data storage device. The data storage device of FIG. 3 includes device 310 having a communications interface 315, a processor 320, non-volatile solid state memory 325, rotating data storage media 335, and a controller 330 that controls the rotating data storage media.

In certain embodiments of the invention, the non-volatile solid state memory 325 may be configured to cache data written to the data storage device, and or cache data that the host is likely to read. Caching data written to the data storage device in non-volatile solid-state memory when the rotating media is off is especially critical because it could take seconds to power up the rotating media. Caching such data insures that the most valuable data will be persistent.

In FIG. 3, the lines between device elements indicate exemplary flow of data, commands, and or other information through the data storage device 310. In operation, a request is received through communications interface 315. The request may be a write request, read request, delete or change request, or some other request. The request is provided from interface 315 to processor 320. Processor 320 may store the instructions on nonvolatile solid state memory 325 for a period of time. The period of time may depend on the power saving techniques utilized by device 310 per the power saving algorithm implemented by processor 320. When processor 320 executes the received instruction, it may signal media controller 330 to power-up rotating medium 335 and perform the request, whether it be one or more read operations, one or more write operations, or other operations. The results of the request are provided or reported to processor 320, and processor 320 may send a confirmation signal, with any results from the request, to the requesting entity via interface 315.

The communication interface 315 may include, among others, data storage device communication interfaces such as ATA, SCSI, SATA, SAS, or PCI interfaces, or the like. The communication interface may also include innovative interfaces connecting the data storage device to non-conventional levels of the system hierarchy such as the cache of the host computer \. The scope of the invention is not limited to a particular type of host interface.

The software for implementing embodiments of the present invention may be stored as one or more modules in memory 325 or 335 of device 310 and loaded into processor 320 for execution by the processor.

The components shown in FIG. 3 are depicted as being connected via a single communication line. However, the components may be connected through one or more data transport means, such as a local microprocessor bus, one or more input/output (I/O) buses, and so forth.

FIG. 4 illustrates a power saving method performed by a data storage device. The steps identified in FIG. 4 (and the order thereof) are exemplary and may include various alternatives, equivalents, or derivations thereof including but not limited to the order of execution of the same. The method of FIG. 4 may be performed entirely by logic within a data storage device such as a disk drive. First requests may be received by a data storage device at step 410. The requests may include read requests, write requests, and other data processing requests and may be received by a device such as device 310.

The received requests are queued at step 415. The requests may be queued in cache or other memory on the data storage device so as not to require a rotating medium to be powered up. A determination is then made as to whether to power-on the rotating medium based on power saving conditions at step 420.

The rotating medium may be powered on or off by the processor based on whether or not power-saving conditions are met. The conditions may include when a threshold number of read requests, write request, total requests, or other data processing requests or operations are received and queued in the non-volatile solid state memory. A condition may also include when an event occurs, such as a time of day during which the rotating medium has a history of being very active. Other conditions that, when met, may trigger a power-on for the rotating medium include, but are not limited to, the number of writes or reads not committed to the rotating medium, the arrival rate of write or read requests, or the read or write request sizes, and the accessibility of requested data in cache memory.

Further examples of conditions that may involve thresholds may include workload predictive history, progressive read, progressive predictive level, or progressive write predictive level. Such thresholds may predict future events based on past history. Examples of predictions include a series of sequential reads, a series of sequential writes, or patterns that the algorithm is familiar with.

If a series of sequential reads can be serviced out of the non-volatile memory, power saving module 232 may include instructions for calculating and/or projecting how many such reads could be serviced out of cache, and power up the rotating medium before a sequential read is received that is not in cache. Likewise, power saving module 232 could power up the rotating medium if a number of sequential writes are observed. The power saving module 232 may also account for and/or consider certain other activity such as when an application is loaded off of a data storage device certain logical blocks or a certain series of logical blocks are read (e.g., the power saving module 232 could identify that an application is loading and turn on the rotating media).

At step 420, if a condition for powering on the rotating medium is not met, the process of FIG. 4 returns to step 410. If such a condition is met, the process continues to step 425 where the rotating medium is powered on. After power-on, one or more of the requests queued in memory may be executed at step 430.

The rotating medium may be powered down at step 435. In some embodiments, one or more conditions or thresholds may be used to power off the rotating medium, such as, for example, the lack of write or read requests received for a period of time, the available space in the queue, and other conditions.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A data storage device for managing power consumption:
a rotating medium for storing non-volatile data;
a processor; and
one or more modules stored on the data storage device and executable by the processor to control a power state of the rotating medium based at least in part on a queued request to read or write to the rotating medium.

2. The data storage device of claim 1, further comprising a non-volatile solid state memory that caches data from at least one of the read or write request.

3. The data storage device of claim 2, wherein the data storage device caches write data from the write requests only when the rotating medium is powered off.

4. The data storage device of claim 1, wherein the processor executes the one or more modules to power on the rotating medium when a power saving condition has been satisfied.

5. The data storage device of claim 4, wherein the power saving condition includes at least one of: a number of writes not committed to rotating medium power up threshold level, an arrival rate of write requests power up threshold level, and size of the data in the request.

6. The data storage device of claim 4, wherein the power saving condition includes at least one of: a workload history power up predictive threshold level, a progressive read power up predictive threshold level, and a progressive write power up predictive threshold level.

7. The data storage device of claim 4, wherein the processor powers-off the rotating medium when a power saving condition has been satisfied.

8. The data storage device of claim 7, wherein the power saving condition includes at least one of: a number of writes not committed to rotating medium power down threshold level, an arrival rate of write requests power down threshold level, and a request size power down threshold level.

9. The data storage device of claim 7, wherein the power saving condition includes at least one of: a workload history predictive power down threshold level, a progressive read predictive power down threshold level, and a progressive write predictive power down threshold level.

10. The data storage device of claim 1, wherein the processor powers on or powers off the rotating medium when upon detecting an event.

11. A method for controlling the power state of a data storage device, the method comprising:
receiving a plurality of requests by a data storage device;
queuing the received requests by the data storage device; and
executing one or more modules on the power saving device by a data storage device processor to determine that one or more power saving conditions are met at the data storage device.

12. The method of claim 11, wherein the requests include read requests and write requests.

13. The method of claim 11, further comprising powering on the rotating medium when the power saving conditions are met.

14. The method of claim 13, wherein the queued requests are performed on the rotating storage when the rotating medium is powered on.

15. The method of claim 11, wherein the power saving condition includes a threshold number of requests stored in non-volatile memory.

16. The method of claim 11, wherein the power saving condition includes determining at least one of a number of writes not committed to rotating medium power up threshold level, an arrival rate of write requests power up threshold level, and a request size power up threshold level.

17. The method of claim 11, wherein the power saving condition includes determining at least one of: a workload history power up predictive threshold level, a progressive read power up predictive threshold level, and a progressive write power up predictive threshold level.

18. The method of claim 11, further comprising powering off the rotating medium when a power down condition has been satisfied.

19. A computer readable storage medium having embodied thereon a program, the program being executable by a processor to perform a method for controlling the power state of a data storage device, the method comprising:
receiving a plurality of requests by a data storage device;
queuing the received requests by the data storage device; and
executing one or more modules to determine that one or more power saving conditions are met.
